(19) United States
(12) Patent Application Publication
(10) Pub. No.: US 2022/0055241 A1
(43) Pub. Date: Feb. 24, 2022

(54) CIRCULAR KNIFE DEVICE

(71) Applicant: Michael Hörauf Maschinenfabrik GmbH und Co. KG, Donzdorf (DE)

(72) Inventor: Reimo ALBERT, Donzdorf (DE)

(21) Appl. No.: 17/407,522

(22) Filed: Aug. 20, 2021

(30) Foreign Application Priority Data
Aug. 21, 2020 (DE) 20 2020 104 847.3

(51) Int. Cl. B26D 1/14; B26D 7/26; B26D 1/143

(52) U.S. Cl. CPC B26D 1/141; B26D 1/1435; B26D 7/2635

(57) ABSTRACT

The invention relates to a circular knife device (10) for cutting to size sheet-like materials, in particular paperboard and/or textile materials, in particular cover boards and/or covering materials, wherein the circular knife device (10) defines a cutting plane in which the sheet-like materials are arranged and are moved in a transport direction (14), having at least one circular knife (46) and an associated circular knife axis, wherein the circular knife (46) is rotatable about the circular knife axis, wherein the at least one circular knife (46) is movable parallel to the cutting plane and perpendicularly to the transport direction (14) with the result that a blank width of the sheet-like materials is settable in a variable manner, wherein the at least one circular knife (46) is mounted so as to be pivotable about a pivot axis (52) arranged substantially perpendicular to the cutting plane such that cuts at an angle to the transport direction (14) and curved cuts of the sheet-like materials are able to be executed.

### CROSS-REFERENCE TO RELATED APPLICATION

This claims priority from German Application No. 20 2020 104 847.3, filed Aug. 21, 2020, the disclosure of which is hereby incorporated by reference in its entirety.

### TECHNICAL FIELD

The invention relates to a circular knife device for cutting to size sheet-like materials, in particular paperboard and/or textile materials, in particular cover boards and/or covering materials, wherein the circular knife device defines a cutting plane in which the sheet-like materials are arranged and are moved in a transport direction, having at least one circular knife and an associated circular knife axis, wherein the circular knife is rotatable about the circular knife axis, wherein the at least one circular knife is movable parallel to the cutting plane and perpendicularly to the transport direction with the result that a blank width of the sheet-like materials is settable in a variable manner.

### BACKGROUND AND SUMMARY

The German laid-open specification DE 102011002473 A1 discloses a circular knife device for cutting to size a flexible back-insert material in the production of book covers. The circular knife device has two circular knives, which can be displaced in a cutting plane relative to one another perpendicularly to a transport direction of the back-insert material through the circular, knife device. As a result, the width of the back-insert material can be set while the back-insert material is passing through the circular knife device.

The European patent EP 2397339 B1 discloses a device for producing book covers, wherein, to produce the book covers, cover boards are covered with a covering material. In order to cut to size covering materials of different sizes from fed standard sizes of covering material, two circular knives that are adjustable perpendicularly to the transport direction of the covering materials are provided, in order to trim the edges of the covering materials to the set dimension.

The European patent EP 1918122 B1 discloses a circular knife device for cutting to size cover boards of book covers. The circular knives can be adjusted manually perpendicularly to the transport direction of the cover boards.

By way of the invention, a circular knife device is intended to be improved in terms of flexibility when cutting to size sheet-like materials with different dimensions.

According to the invention, to this end, a circular knife device having the features of claim 1 is provided. Advantageous features and developments of the invention can be found in the dependent claims.

A circular knife device for cutting to size sheet-like materials, in particular paperboard and/or textile materials, in particular cover boards and/or covering materials, defines a cutting plane in which the sheet-like materials are arranged and are moved a transport direction. The circular knife device has at least one circular knife and an associated circular knife axis, wherein the circular knife is rotatable about the circular knife axis. The at least one circular knife is movable parallel to the cutting plane and perpendicularly to the transport direction with the result that a blank width of the sheet-like materials is settable in a variable manner. The at least one circular knife is furthermore mounted so as to be pivotable about a pivot axis arranged substantially perpendicular to the cutting plane such that cuts at an angle to the transport direction and curved cuts of the sheet-like materials are able to be executed. Since cuts at an angle to the transport direction and also curved cuts can be executed, the circular knife device according to the invention can be used in a very flexible manner. Specifically, very different blanks can be produced and so for example only a standard format of a sheet-like material needs to be fed. This makes storage much easier. The setting of the at least one circular knife can in this case take place automatically and in a manner coordinated with a cyclical or non-cyclical feed of the sheet-like material and also depending on a transport speed of the sheet-like material. The setting can, as a result, take place during ongoing operation and, for example, batch sizes of one axe also producible. Advantageously, the circular knife, even during a cutting operation, is pivotable through an angle of ±30⁰ with respect to the transport direction. The pivotable circular knife can be entrained in rotation by means of a roller-like counter bearing or be driven itself. The pivotable circular knife can also be assigned a counter knife that is pivotable in the same direction.

In a development of the invention, the at least one circular knife is rotatable about the circular knife axis and is mounted on a pivoting element, the pivoting element is rotatable about the pivot axis and is mounted on a linear guide element, and the linear guide element is arranged so as to be displaceable along a linear guide parallel to the cutting plane. The circular knife can, as a result, be pivoted and displaced simultaneously such that oblique cuts, curved cuts or even undulating cuts of the sheet-like material are possible. The circular knife device according to the invention is usable in an extremely flexible manner as a result.

In a development of the invention, a first actuator, in particular a servomotor, for pivoting the pivoting element about the pivot axis is provided. As a result, the automatic pivoting of the circular knife is possible, even during ongoing operation of the circular knife device.

In a development of the invention, a second actuator, in particular a servomotor, for displacing the linear guide element parallel to the cutting plane is provided. In this way, the circular knife can be displaced perpendicularly to the transport direction automatically, even during ongoing operation of the circular knife device.

In a development of the invention, a control unit is provided in order to set a pivot angle of the circular knife about the pivot axis depending on a transport speed and/or a position of the sheet-like materials relative to the circular knife. In this way, a pivoting movement of the circular knife about the pivot axis and a displacement movement of the circular knife perpendicular to the transport direction can be coordinated with one another while sheet-like materials are being transported through the circular knife device, such that oblique and curved cuts of the sheet-like materials are possible. Specifically, the control unit and/or a computer program running on the control unit is/are provided and configured to set a position of the linear guide element relative to the linear guide depending on a transport speed and/or a position of the sheet-like materials relative to the circular knife.

In a development of the invention; at least one bracket configured in a U-shaped or C-shaped manner is provided, between the legs of which the cutting plane is arranged and on which the at least one circular knife is arranged. By means of U-shaped or C-shaped brackets, a very stable arrangement of the circular knife or of a plurality of circular knives can be ensured, such that very precise cuts are possible.

In a development of the invention, two brackets configured in a U-shaped or C-shaped manner are provided, the open sides of which face one another. As a result, sheet-like materials can be transported through between the legs of the brackets. The brackets provide a very stable mounting option for circular knives, counter bearings, counter knives and/or rollers for guiding and moving the sheet-like materials.

In a development of the invention, two circular knives are arranged between the two brackets, wherein in each case one circular knife is mounted in a rotatable manner on one of the brackets. Such circular knives can be used, in the case of book covers, for cutting to size a spine reinforcement or a back insert of the book covers.

In a development of the invention, a third actuator is provided in order to set a spacing of the two circular knives relative to one another in the cutting plane. Advantageously, a control unit is also provided in order to set the third actuator depending on a position and/or a transport speed of the sheet-like materials. In this way, a back-insert width can also be set during ongoing operation of the circular knife device and interruption-free operation, even in the case of a batch size of one, is possible. For example, a spacing of the circular knives with respect to one another is adjusted before a further cover board is fed to the circular knife device.

In a development of the invention, the at least one bracket is arranged in a displaceable manner on a machine frame and is displaceable perpendicularly to the transport direction relative to the machine frame. As a result, the circular knives can be mounted for example in a rotatable manner on the bracket but not in a displaceable manner on the bracket. In order to set a back-insert width or a width of the cover boards, the entire bracket can be displaced relative to the machine frame and relative to the fed sheet-like materials.

In a development of the invention, a shredder can be arranged downstream of the circular knives on the machine frame of the circular knife device. In this way, cut-away pieces of sheet-like materials can be cut up into small pieces and immediately disposed of.

Further features and advantages of the invention will become apparent from the claims and the following description of a preferred embodiment of the invention in conjunction with the drawings. In the drawings:

### BRIEF DESCRIPTION OF THE DRAWINGS

FIG. 1 shows an isometric illustration of a circular knife device according to the invention obliquely from the front,

FIG. 2 shows two examples of possible ways of cutting a sheet-like material blank with the circular knife device in FIG. 1,

FIG. 3 shows a front view of the circular knife device in FIG. 1,

FIG. 4 shows an enlarged detail of the circular knife device in FIG. 1,

FIG. 5 shows an illustration of the circular knifes of the circular knife device according to the invention, wherein numerous elements of the circular knife device have been omitted for the sake of clarity, and

FIG. 6 shows the arrangement in FIG. 5 from above.

### DETAILED DESCRIPTION

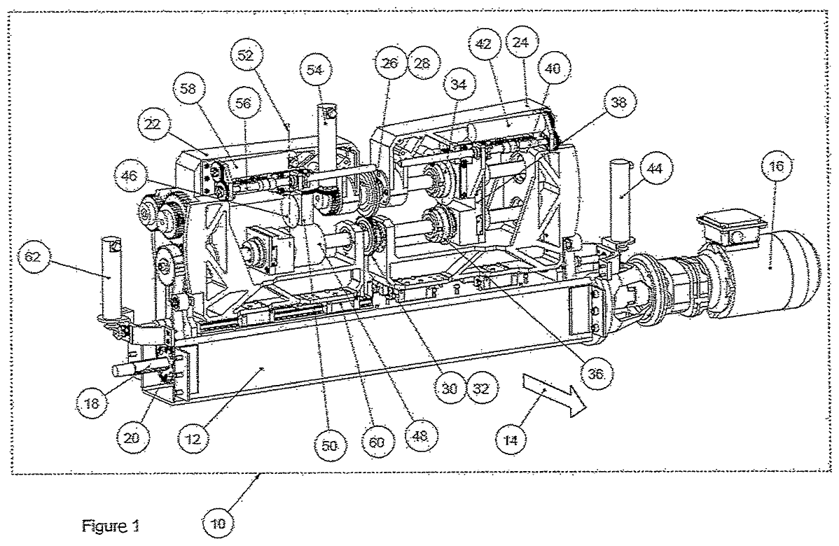

FIG. 1 shows a circular knife device 10 according to the invention in a view obliquely from the front. The circular knife device 10 can be for example part of a book cover making machine (not illustrated), but it can also be configured as a separate unit that is possibly even movable and able to be coupled to some other machine as required.

The circular knife device 10 has a machine frame 12, which is configured as a square beam arranged transversely to a transport direction 14 through the circular knife device 10. As stated, the machine frame 12 can also be part of a machine frame of a book cover making machine (not illustrated). The beam is hollow and, starting from an electric motor 16, which is arranged at a first end, illustrated on the right in FIG. 1, of the beam, a drive shaft 18 extends through the entire beam and is accessible, inter alfa, at the second end of the beam, which is illustrated on the left in FIG. 1. At that end of the drive shaft 18 that is visible in FIG. 1, a drive wheel 20 is mounted, with which a plurality of circular knives and a counter bearing for a circular knife are driven via a toothed belt and a plurality of gearwheels. Rather than a toothed belt, it is, of course, also possible to use chains, only gearwheels or other gear mechanisms. In the same way, a further drive wheel for a toothed belt is mounted at the concealed right-hand end of the beam 12.

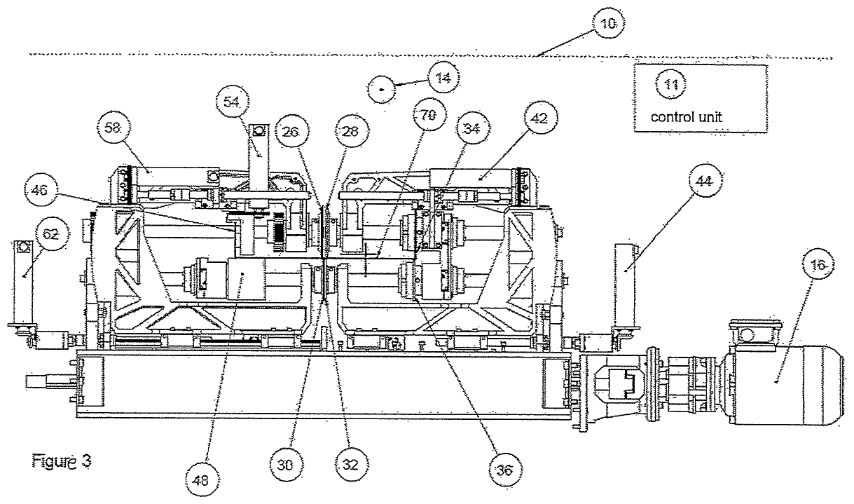

The circular knife device 10 has two C-shaped brackets 22, 24, which are arranged on the beam of the machine frame 12 with their open sides facing one another. The two brackets 22, 24 are arranged with their respectively parallel legs perpendicular to the transport direction 14. Arranged between the two brackets 22, 24 are two circular knives 26, 28, to each of which a counter knife 30, 32 is assigned; see also FIG. 3. The circular knives 26, 28 and the counter knives 30, 32 are each oriented parallel to the transport direction 14 and provided to cut a middle reinforcement or a back insert for a book cover out of a fed paperboard blank. The circular knives 26, 28 are respectively arranged on separate drive shafts, which are driven by the electric motor 16 by means of gear mechanisms that are only partially discernible in FIG. 1. The counter knives 30, 32, too, are arranged respectively on separate drive shafts, which are driven by means of the electric motor 16. The circular knives 26, 28 and the counter knives 30, 32 are each driven such that a sheet-like blank is conveyed in the transport direction through the circular knife device 10 while it is being cut to size. Driving of the drive shafts by means of separate electric motors that are coordinated with one another is possible within the scope of the invention.

Arranged between the legs of the right-hand bracket 24 in FIG. 1 is a further circular knife 34, to which a further counter knife 36 is assigned. The circular knife 34 is arranged on the same drive shaft as the circular knife 28 and the counter knife 36 is arranged on the same drive shaft as the counter knife 32. The circular knife 34 and the counter knife 36 are provided to trim the lateral edge of a fed sheet-like blank. The circular knife 34 and the counter knife 36 are both mounted on a carriage 38 that is movable transversely to the transport direction 14 and is mounted in a displaceable manner on that leg of the bracket 24 that is arranged at the top in FIG. 1. In order to displace the carriage 38, a spindle drive having a threaded spindle 40 is provided, which is driven by means of a servomotor 42. As a result, the width of a cover board can be set, which is cut out of a fed sheet-like blank.

The bracket 24 is furthermore arranged on the beam of the machine frame 12 so as to be displaceable perpendicularly to the transport direction 14. To this end, the lower leg, in FIG. 1, of the bracket 24 is fastened to the beam by means of a linear guide that is only partially illustrated in FIG. 1. In order to displace the bracket 24 relative to the beam and thus perpendicularly to the transport direction 14, a servomotor 44 is provided, which drives a threaded spindle. By means of a displacement of the bracket 24 perpendicular to the transport direction, a spacing between the circular knife 28 and the circular knife 26, or a spacing between the counter knife 32 and the counter knife 30, can be set. Thus, a width of the spine reinforcement or of the back insert can be set, which is cut out of a fed sheet-like blank.

Arranged between the legs of the left-hand bracket 22 in FIG. 1 is a further circular knife 46. The circular knife 46 is assigned a roller-like counter bearing 48. The counter bearing 48 can be configured as a steel roll. Alternatively, rather than the counter bearing 48, a counter knife can be provided, which is pivoted in the same direction as the circular knife 46. The circular knife 46 and the counter bearing 48 form a crush-cut knife arrangement with which a fed sheet-like blank can be cut. The counter bearing 48 is arranged on the same drive shaft as the counter knife 30 and is driven jointly with the counter knife 30 by the electric motor 16. In the context of the invention, it is possible for the counter bearing 48 to be driven by means of a separate electric motor.

The circular knife 46 is mounted so as to be rotatable about its circular knife axis on a pivoting element 50 which is in turn arranged so as to be pivotable about a pivot axis 52 arranged perpendicularly to the transport direction 14, As a result of the circular knife 46 being pivoted about the pivot axis 50, the circular knife 46 can be set either parallel or at an angle to the transport direction 14. As a result, cuts that are parallel to the transport direction 14 or cuts that are at an angle to the transport direction 14 are possible, If the setting angle of the circular knife 46 is changed during a cutting operation and a movement of a sheet-like blank in the transport direction 14, curved cuts are also possible. To set an angular position of the pivoting element 50 and thus of the circular knife 46 about the pivot axis 52, a servomotor 54 is provided. The pivoting element 50 is arranged on the bracket 22 so as to be displaceable perpendicularly to the transport direction and thus parallel to the upper leg, in FIG. 1, of the bracket 22 by means of a linear guide that is only partially visible in FIG. 1. To adjust the pivoting element perpendicularly to the transport direction 14, a threaded spindle 56 is provided, which is driven by means of a servomotor 58. The linear guide is arranged directly behind the threaded spindle 56 and partially concealed by the threaded spindle 56. The circular knife 46 is not driven in the embodiment illustrated but rather is entrained by the counter bearing 48 and driven thereby. In the context of the invention, the provision of a separate drive motor for the circular knife 46 is possible, With the circular knife 46, a lateral edge of a fed sheet-like blank can be trimmed, as stated, either parallel to the transport direction 14, at an angle to the transport direction 14, or in a curved manner.

The bracket 22 is arranged on the beam of the machine frame 12 so as to be displaceable perpendicularly to the transport direction 14 by means of a linear guide 60. Displacement of the bracket 22 along the linear guide 60 is effected by means of a servomotor 62, which drives a threaded spindle. By means of a displacement of the bracket 22 perpendicular to the transport direction 14, a spacing between the circular knife 26 and the circular knife 28, or a spacing between the counter knife 30 and the counter knife 32, can be set. By means of a displacement of the bracket 22 perpendicular to the transport direction 14, it is thus possible for a width of a spine reinforcement or of a back insert to be set, which is cut out of a fed sheet-like blank. By displacing both the bracket 22 and the bracket 24 perpendicularly to the transport direction, a width of a spine reinforcement back insert to be cut can be changed while maintaining the width of cover boards being cut at the same time. This is because the circular knives are arranged rotatably on the brackets 22, 24 and are moved together with the brackets 22, 24.

The circular shear device according to the invention allows numerous setting options when cutting a fed sheet-like blank by means of the circular knives 26, 28, 34 and 46. The stable configuration by means of the two C-shaped brackets, on which the circular knives 26, 28, 34 and 46 and the associated counter knives 30, 32, 36 and counter bearing 48 are guided, allows very precise cuts here.

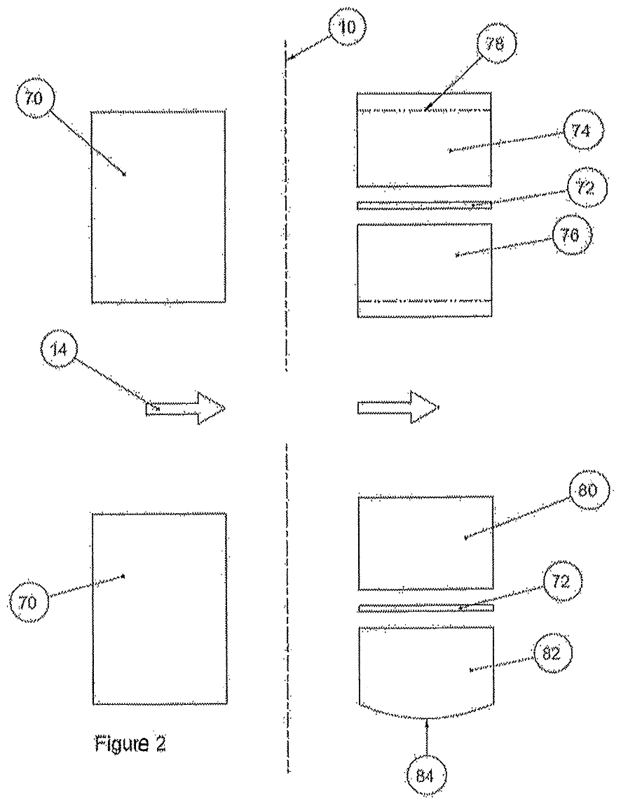

FIG. 2 shows two examples of how a fed sheet-like blank 70 can be cut to size with the circular knife device according to the invention.

At the top of FIG. 2, a sheet-like blank, made for example of paperboard material for producing cover boards for a book spine, is fed in the transport direction 14 to the circular knife device 10, which is symbolized in FIG. 2 only as a vertical dot-dash line. The sheet-like blank, for example paperboard, is separated from a paperboard stack, wherein, by means of paperboard pushers, the respectively bottommost paperboard blank is separated and pushed to the circular knife device. The paperboard pushers are not shown in FIG. 1 or FIG. 2 but the design and arrangement of paperboard pushers is well known to the person skilled in the art. As soon as the circular knives 26, 28, 34, 46, the counter knives 30, 32, 36 and the counter bearing 48 have collected the sheet-like blank or the paperboard, it is transported onward through the circular knife device 10 by means of the circular knives, counter knives and counter bearing 48. By means of the circular knives 26, 28 and the associated counter knives 30, 32, a spine reinforcement or a back insert 72 is cut. At the same time, during the cutting of the back insert 72, the inner lateral edges of the cover boards 74, 76 are cut. The upper lateral edge 78, in FIG. 2, of the cover board 74 is cut with the circular knife 34 and the counter knife 36. The lower lateral edge, in FIG. 2, of the cover board 76 is cut with the circular knife 46 and the counter bearing 48. After the cover boards 74, 76 and the back insert 72 have been cut, the setting of the circular knives, counter knives and counter bearings of the circular knife device can remain unchanged or at least partially be changed in order to cut other sizes of cover boards and back insert to size. With the circular knife device 10 according to the invention, adjustment during ongoing operation can take place after the sheet-like blank 70 has passed through, for example even to realize a batch size of one.

The bottom of FIG. 2 illustrates how the sheet-like blank is cut to form a back insert 72 and two cover boards 80, 82. The back insert 72 has unchanged dimensions compared with the back insert illustrated at the top in FIG. 2. The cover board 80 has a greater width than the cover board 74. The cover board 82 has a convex lateral edge located at the bottom in FIG. 2. This is achieved in that the circular knife 46 is arranged at a first angle to the transport direction 14 at the start of the cutting operation. The angle is gradually reduced to zero while the circular knife 46 is moved simultaneously outward, that is to say downward in FIG. 2. This movement is stopped as soon as the angle of the circular knife 46 to the transport direction 14 has been reduced to zero, i.e. when the point 84 of the lateral edge has been reached. Then, the angle of the circular knife 46 to the transport direction 14 is gradually increased again in the opposite direction and the circular knife 46 is moved simultaneously back inward, that is to say upward in FIG. 2, until the starting position has been reached and the angle of the circular knife to the transport direction 14 corresponds to the value of the starting angle but with the opposite sign. As a result of movements of the circular knife 46 that are coordinated with a transport speed of the sheet-like blank, it is possible for different profiles of the lateral edge to be cut, for example lateral edges extending at an angle to the transport direction 14, concavely curved lateral edges or lateral edges extending in an undulating manner, or even lateral edges extending in a partially curved and partially straight manner.

With the circular knife device 10, only the lateral edge of the cover boards 76, 82 that is located respectively at the bottom in FIG. 2 can be configured with a different profile. In the context of the invention, it is also possible, however, to provide in the bracket 24 a circular knife that is pivotable about a pivot axis perpendicular to the transport direction, in order to also provide the lateral edge of the cover boards 74, 80 that is located at the top in FIG. 2 with lateral edges with different profiles.

Of course, the described configuration and pivotable arrangement of the circular knife 46 can also be used when cutting covering materials or other sheet-like blanks to size.

Cut-away pieces of the blank 70 are not shown in FIG. 2. Such cut-away pieces can immediately be forwarded to a shredder which forms part of the circular knife device 10. Thereby, the cut-away pieces can be immediately disposed of.

FIG. 3 shows the circular knife device 10 in Figure from the front, counter to the transport direction 14. The circular knife 46 is oriented parallel to the transport direction 14 in the state in FIG. 3. The sheet-like blank 70 is arranged in the circular knife device 10 and between the circular knives 26, 28 and the counter knives 30, 32, between the circular knife 46 and the counter bearing 48 and between the circular knife 34 and the counter knife 36. The circular knives 26, 28, 34 and counter knives 30, 32, 36, which are driven in rotation, and the likewise driven counter bearing 48 convey the sheet-like blank 70 through the circular knife device 10. A control unit 11 is illustrated only schematically and can control the servomotors 42, 44, 54, 58, 62, in particular in a manner coordinated with a transport speed that is defined by the rotational speed of the electric motor 16. In the context of the invention, the control unit 11 can also control or regulate a rotational speed of the electric motor 16.

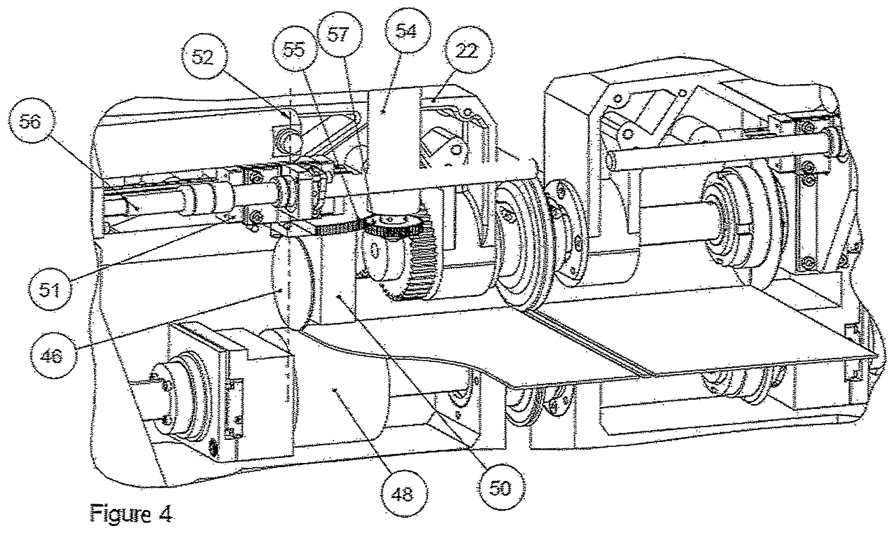

FIG. 4 shows an enlarged detail of the circular knife device 10. The pivoting element 50, on which the circular knife 46 is mounted in a rotatable manner and which is itself arranged in a pivotable manner on a bearing block 51, can be seen. The bearing block 51 is in turn, as stated above, fastened to a longitudinal guide and can be displaced parallel to the upper leg of the bracket 22 by means of the threaded spindle 56. A pivoting movement of the pivoting element 50 is effected by means of the servomotor 54. A gearwheel segment 55 on the pivoting element 50, in which a gearwheel 57 engages which is connected to the shaft of the servomotor 54, is only schematically indicated.

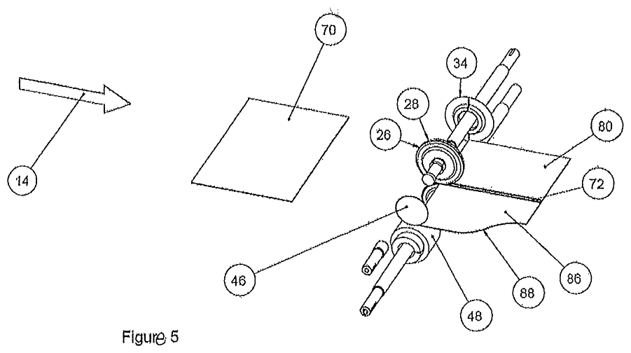

FIG. 5 shows only a part of the circular knife device 10 in order to clarify the arrangement of the circular knives 26, 28, 34 and 46 and of the counter bearing 48. A sheet-like blank 70 is just being fed to the circular knife device, while a further blank has already been cut to size to form two cover boards 80, 86 and a back insert 72. The cover board has straight lateral edges, whereas the outer lateral edge 88, located at the bottom in FIG. 5, of the cover board 86 has a curved profile. As seen counter to the transport direction 14, the lateral edge 88 first of all starts parallel to the transport direction 14, then extends outward in a concavely curved manner and changes curvature about half-way along the length of the cover board 86, and then extends further. An a convexly curved manner, in order to end parallel to the transport direction 14 again at the end of the cover board 86. This profile of the lateral edge 88 is achieved in that the circular knife 46 is oriented parallel to the transport direction at the start of the cutting operation, is then gradually rotated outward at an angle and, starting from the middle of the blank 70, the angle of the circular knife 46 to the transport direction 14 is then gradually reduced to zero again. A movement of the circular knife 46 perpendicularly to the transport direction 14 takes place here in a coordinated manner.

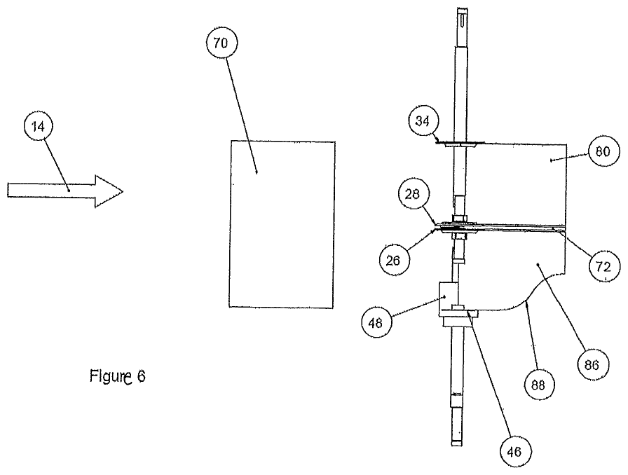

FIG. 6 shows the part of the circular knife device in FIG. 5 from above. The counter bearing 48 and the circular knives 46, 26, 28 and 34 can be seen.

1. Circular knife device (10) for cutting to size sheet-like materials, in particular paperboard and/or textile materials, in particular cover boards and/or covering materials, wherein the circular knife device (10) defines a cutting plane in which the sheet-like materials are arranged and are moved in a transport direction (14), having at least one circular knife (46) and an associated circular knife axis, wherein the circular knife (46) is rotatable about the circular knife axis, wherein the at least one circular knife (46) is movable parallel to the cutting plane and perpendicularly to the transport direction (14) with the result that a blank width of the sheet-like materials is settable in a variable manner, characterized in that the at least one circular knife (46) is mounted so as to be pivotable about a pivot axis (52) arranged substantially perpendicular to the cutting plane such that cuts at an angle to the transport direction (14) and curved cuts of the sheet-like materials are able to be executed.

2. Circular knife device according to claim 1, characterized in that the circular knife (46) can be pivoted through an angle of ±30° with respect to the transport direction.

3. Circular knife device according to claim 1 or 2, characterized in that the at least one circular knife (46) is rotatable about the circular knife axis and is mounted on a pivoting element (50), in that the pivoting element (50) is rotatable about the pivot axis (52) and is mounted on a linear guide element, and in that the linear guide element is arranged so as to be displaceable along a linear guide parallel to the cutting plane.

4. Circular knife device according to claim 3, characterized in that a first actuator, in particular a servomotor (54), for pivoting the pivoting element (50) about the pivot axis (52) is provided.

5. Circular knife device according to claim 3 or 4, characterized in that a second actuator, in particular a servomotor (58), for displacing the linear guide element parallel to the cutting plane is provided.

6. Circular knife device according to one of the preceding claims, characterized in that a control unit (11) is provided in order to set a pivot angle of the circular knife (46) about the pivot axis (52) depending on a transport speed and/or a position of the sheet-like materials relative to the circular knife (46).

7. Circular knife device according to claim 6, characterized in that the control unit (11) is provided in order to set a position of the circular knife (46) relative to the linear guide depending on a transport speed and/or a position of the sheet-like materials relative to the circular knife (46).

8. Circular knife device according to at least one of the preceding claims, characterized in that at least one bracket (22, 24) configured in a U-shaped or C-shaped manner is provided, between the legs of which the cutting plane is arranged and on which the at least one circular knife (46) is arranged.

9. Circular knife device according to claim 8, characterized in that two brackets (22, 24) configured in a U-shaped or C-shaped manner are provided, the open sides of which face one another.

10. Circular knife device according to claim 9, characterized in that two circular knives (26, 28) are arranged between the two brackets (22, 24), wherein in each case one circular knife (26, 28) is mounted in a rotatable manner on one of the brackets (22, 24).

11. Circular knife device according to claim 10, characterized in that at least one third actuator (44, 62) is provided in order to set a spacing of the two circular knives (26, 28) relative to one another in the cutting plane.

12. Circular knife device according to claim 11, characterized in that a control unit (11) is provided in order to set the third actuator (44, 62) depending on a position and/or a transport speed of the sheet-like materials.

13. Circular knife device according to at least one of claims 8 to 12, characterized in that the at least one bracket (22, 24) is arranged in a displaceable manner on a machine frame (12) and is displaceable perpendicularly to the transport direction (14) relative to the machine frame (12).
